(19) United States
(12) Patent Application Publication
(10) Pub. No.: US 2006/0206370 A1
(43) Pub. Date: Sep. 14, 2006

(54) Smart work-force tool

(75) Inventor: Eugene Skopal, Ossining, NY (US)

Correspondence Address: HOFFMANN & BARON, LLP, 6900 JERICHO TURNPIKE, SYOSSET, NY, 11791, US

(73) Assignee: Netspace Technology LLC.

(21) Appl. No.: 11/280,841

(22) Filed: Nov. 16, 2005

Related U.S. Application Data
(60) Provisional application No. 60/628,281, filed on Nov. 16, 2004.

(51) Int. Cl. G06F 15/02; G06F 9/46

(52) U.S. Cl. 705/9

(57) ABSTRACT

The invention further provides a method for providing workforce management and collaborative support amongst a plurality of entities comprising; aggregating in a comprehensive database a set of data, documentation, instructions and tools for the performance of at least one task, loading the comprehensive database onto at least one computer for the performance of the tasks, performing the at least one task, creating a record of the execution of the at least one task, adding entities through the process comprising; requesting assistance from at least one support entity by any of the plurality of entities, wherein requesting assistance includes; creating a classification database of resource classifications, sharing the database among a plurality of resources and resource users, registering an address and resource classification for each of the plurality of resources, receiving a request for at least one resource from the resource user, searching for at least one matching resource, and returning the resource to the resource user, creating an electronic communication link from the support entity to the entity, providing the record from the entity to the support entity, and sharing control of the executing of the at least one task.

### CROSS-REFERENCE TO RELATED APPLICATIONS

This application claims the benefit of U.S. Provisional Application No. 60/628,281 filed on Nov. 16, 2004, entitled “Smart Work-Force Tool”.

### FIELD OF THE INVENTION

The present invention relates to an expert system for providing automated workforce management, collaboration, coordination and forensic record keeping.

### BACKGROUND OF THE INVENTION

The current practice for providing technical support for surveying, installing, upgrading, or maintaining sophisticated computer, networking, multimedia, telephony, and other technologies is to maintain a group of highly trained individuals who can be dispatched to handle any of these tasks. These technicians are limited to performing these tasks to the equipment for which they have received training. Furthermore, technicians are usually physically limited to a defined geographic region. Finally, hiring or training technicians to such a high level of expertise is very expensive.

Once a technician has been dispatched, the work to be done must be communicated to him or her. These actions, often conveyed via Telephone, e-mail, or other in-house systems, are time-consuming and subject to error. In addition, the technician needs to provide and/or bring all required collateral to perform the task, e.g., specialized software, documentation, firmware, contact information, escalation procedures, and so on. This collateral varies with each technician and project, and the technician is usually responsible for knowing what collateral he might need. If any collateral has been forgotten by the technician, he or she would need to connect to Internet to recall it, or find a FAX machine to have it sent to him or her.

Since technical staff has to be physically close to the location of the problem or task to be performed, companies are often forced to build geographically dispersed offices or to use sub-contractors, both of which cut into profit margins drastically.

It is a problem in field service scenarios, such as the servicing of sophisticated computer networking hardware, for example, that the systems can be complicated to install and maintain, and require a significant learning curve to achieve mastery of the entire system by a field service technician.

In addition, due to the complexity of tasks and the high degree of training necessary to perform most field service tasks, it is usually necessary to employ individuals with a high degree of technical skill and aptitude.

Typically in a field environment, a technician who has some level of training is dispatched to a field (remote) location to survey, install, service, troubleshoot, or upgrade a piece of equipment, such as a computer network router. The technician will, of course, have a level of expertise in performing his assigned tasks.

Generally, the technician is provided with a physical or electronic Work Order or Statement of work detailing his assigned tasks. Often, these instructions are complex and difficult to write and/or understand. The technician is responsible for bringing along any tools, documentation, software, equipment, and contact information he might need to perform these tasks. If either the technician does not have access to the appropriate tools, documentation, software, equipment, or contact information; or he forgets to bring something he needs, he is likely to fail to complete the tasks itemized in the Work Order.

The technician may be trained for working with a variety of systems or addressing a particular problem or issue. However, not all technicians will be able to address all problems or issues that may arise for a complicated piece of equipment or a complex task. Furthermore, to train each technician to be able to address all possible tasks is prohibitively expensive in terms of both time and money.

In addition, the Work Order may generally describe the work to be completed, but may not list each particular step and generally leave the details to the technician's training and discretion. Furthermore, the Work Order would not typically include a list of parts, tools, or other resources needed to complete an assigned task. These other resources may include software such as drivers and other utilities and contact information for technical help.

Finally, non-technical problems may arise which prevent a technician from completing a task. These can include: scheduling problems such as arriving at the incorrect time or date, location problems such as improper directions or address information being given to the technician, and human interface problems such as the technician not being provided with the correct contact individual at a job site. All of these non-technical problems can still act as a serious impediment to a field service technician completing his tasks.

For these reasons, and any number of additional reasons, the technician may not be able to complete the tasks assigned. When this happens, the technician will need to go through a laborious and time-consuming process to obtain the necessary resources to complete the tasks assigned. This may include leaving the jobsite to gather the required tools, equipment or software for example, or to track down and contact the appropriate help-desk or expert resource needed to resolve the issue. Contacting the appropriate technical assistant is an especially difficult task in many instances and may require several time consuming cycles of communicating what tasks are being performed, what the issues are, what steps have been taken up to this point, and who has already been contacted in an attempt to remedy the problem.

Once the appropriate help-desk or expert resource has been located and briefed, a tedious, work intensive and inefficient cycle of troubleshooting begins with the help-desk or expert asking the technician to perform some task and relay the results to the helper. If the problem can not be resolved, another cycle of locating a more senior, specialized and knowledgeable support resource begins. In each case of locating a help-desk support individual, the field service technician must relay the problem information from the beginning to the most recently contacted support personnel. This produces an inefficient and redundant support process where the technician must repeat, possibly several times, the nature of the problem encountered as well as the possible solutions attempted by other support personnel in the previous iterations of the support cycle.

Given that the issue is eventually resolved, it is likely that other technicians will run into the same or similar issues, particularly on large projects where the same tasks are to be performed in numerous sites. This will result in this scenario being played out repeatedly until updated procedures, documentation, software, etc., can flow out to the technicians performing the tasks.

Some problems are so difficult that help is needed from more than one person at the same time. Thus, telephone calls in general, and conference calls, in particular must be used to convey information among the technician and the numerous helpers. Occasionally, online support systems such as Instant Messaging are used to communicate between people on the Internet. Furthermore, the resolution to a problem may also require the technical assistant to be provided with visual input in order to fully understand the problem in order to devise a solution. Therefore, a telephone call may not always suffice in providing the technical assistant enough information to resolve a problem.

Another common possibility is that the same or similar issue does occur, but not until after the help-desk or expert resource that had the “institutional knowledge” of how to handle the issue is no longer available: the solution now has to be relearned. This situation can be encountered where a single individual or limited group of individuals encounters a specific problem and develops a solution for the problem without documenting the solution, or documents it in a way that is not distributed widely within the department or is documented in such as way that it is not easily understood. Thus, if the individual or small group of individuals is not available at a specific time to address a problem then the value of their solution is wasted. Furthermore, even if the individual having the pertinent institutional knowledge is available, the solution to the problem may not have been properly documented or it may have been some time since the previous occurrence of the same problem and therefore the solution may be hard to retrieve. Therefore, proper cataloging of all solutions is necessary in order to insure efficient retrieval of any particular solution. The mere existence of the knowledge is wasted if it is not easily and efficiently accessed.

Thus, there is a problem with retaining knowledge of what went wrong in the field, why it went wrong, and what the correct solution in previous occurrences. This is often referred to as “brain drain”, where specialized information on how to perform tasks is lost when key personnel leave the company.

Accurate records must be kept on what steps have been performed on equipment for maintenance, forensic, or training purposes. Often, simple logs are used, but these logs are often neglected or mislaid, and therefore lose their utility.

Along the same lines, there is a need to keep accurate time and expense records for customer billing and technician payroll. Time sheets (paper and/or electronic), emails, in-house timesheet systems, and electronic expense reports are all partial solutions, but it is difficult to keep a consolidated record, particularly associated with the work actually being done. This can be exacerbated in a field service scenario when a technician is overwhelmed by a difficult problem. In that case, record keeping for billing purposes may be overlooked, and need to be recreated later from memory. This however, can lead to errors and oversights.

The current model for providing field service support is inefficient and does not assure high levels of satisfaction for the technical service contractor or their customers. The issues above represent resource management problems that translate to additional expenses for the technical service contractor due to increased time in completing an assignment resulting in lost profitability and list customers.

Therefore, in view of the above described problems of the prior art systems the present invention provides an automated and highly structured system and process for allowing a non-expert technician or even a non-technical person to complete a task or series of tasks and invoke support from a multitude of expert personnel and systems in real time, from remote locations.

Furthermore, everything that occurs in this process—the questions, answers, and solutions is automatically retained as part of the “recording” for future reference and auditing purposes.

### BRIEF SUMMARY OF THE INVENTION

The present invention is directed to a computerized system and method preferably for use in a geographically dispersed environment to enable workforce management, collaboration, coordination, and record keeping.

More particularly, this invention further provides for a computer-implemented system and method for providing a user with a task list, real time communications with a plurality of remote users, and real time dynamic record keeping of all actions, interfaces and communications which occur during the course of a particular project or session.

It is therefore an objective of the computer assisted system and method of the present invention to provide a support system to allow individuals without a high degree of technical training to perform tasks usually requiring highly-skilled and educated technicians.

It is further an objective of the computer assisted system and method of the present invention to provide service personnel with a highly-formalized and extensible set of documentation relating to a job in a portable format. This set of documentation is known as a “Work Packet”, and may include one or more sections, such as a work order detailing the service individual's assigned tasks, and a list of tools, documentation, software, equipment, scheduling, address, and contact information he might need to perform the task. The Work Packet is typically comprised of an electronic component as well as non-electronic components.

It is a further objective of the present invention to provide computerized system and method for contacting expert support personnel as needed to assist in trouble-shooting a problem. The present invention provides a system whereby experts are pre-qualified and listed within a central database together with contact information and areas of expertise. Those experts can then be contact quickly and efficiently on an as-needed basis.

It is a further objective of the present invention to support auditing and quality control by providing a system and method for maintaining a record of all steps taken to correct a particular problem. This functionality satisfies the dual purpose of maintaining institutional knowledge of the steps taken to rectify a problem as well as providing an accurate log of all actions for evaluation by quality control personnel. The record can also be useful in troubleshooting and debugging equipment or a system by providing a log of the steps to solve a problem, which can lead to the origins of a problem.

The present invention provides a system and method of presenting a highly structured, uniform set of detailed instructions and checklists for completing a particular task as well as all non-technical information, e.g., job date, address, and directions to the location and contact information.

The invention comprises providing workforce management by aggregating in a comprehensive database a set of data, documentation, instructions and tools for the performance of at least one task, loading the comprehensive database onto at least one computer for the performance of the tasks, performing said at least one task, and creating a record of said execution of said at least one task.

The invention further provides a method for providing real time collaborative support amongst a plurality of entities comprising; executing by an entity at least one activity, creating a record of the execution of the at least one activity, adding entities through the process comprising; requesting assistance from at least one support entity, by any of the plurality of users, creating an electronic communication link from the support entity to the entity, providing the record from the entity to the support entity, and sharing control of the executing of the at least one activity.

The invention further provides a method for coordinating collaborative resources comprising; creating a classification database of resource classifications, sharing the database among a plurality of resources and resource users, registering an address and resource classification for each of the plurality of resources, receiving a request for at least one resource from the resource user, searching for at least one matching resource, and returning the resource to the resource user.

The invention further provides a method for providing workforce management and collaborative support amongst a plurality of entities comprising; aggregating in a comprehensive database a set of data, documentation, instructions and tools for the performance of at least one task, loading the comprehensive database onto at least one computer for the performance of the tasks, performing the at least one task, creating a record of the execution of the at least one task, adding entities through the process comprising; requesting assistance from at least one support entity by any of the plurality of entities, creating an electronic communication link from the support entity to the entity, providing the record from the entity to the support entity, and sharing control of the executing of the at least one task.

The invention further provides a method for providing workforce management and collaborative support amongst a plurality of entities comprising; aggregating in a comprehensive database a set of data, documentation, instructions and tools for the performance of at least one task, loading the comprehensive database onto at least one computer for the performance of the tasks, performing the at least one task, creating a record of the execution of the at least one task, adding entities through the process comprising; requesting assistance from at least one support entity by any of the plurality of entities, wherein requesting assistance includes; creating a classification database of resource classifications, sharing the database among a plurality of resources and resource users, registering an address and resource classification for each of the plurality of resources, receiving a request for at least one resource from the resource user, searching for at least one matching resource, and returning the resource to the resource user, creating an electronic communication link from the support entity to the entity, providing the record from the entity to the support entity, and sharing control of the executing of the at least one task.

The invention further provides a method for allowing at least one user to interact simultaneously with multiple entities comprising; creating an event database for storing events comprising a time stamp, a channel, a user and event data, assigning channels to each input of the devices, assigning channels to each output of the devices, assigning a user identification to each of the at least one users, recording events in the event database wherein each event is recorded with the time stamp, the channel and the users, displaying the events to one of the at least one users based upon pre-determined criteria.

In accordance with the present invention, information is disseminated and shared quickly and automatically, which is a marked improvement over prior art, where cumbersome and oft-erroneous ad hoc methods must be implemented to disseminate new information.

In addition, real time communication, collaboration and coordination between a plurality of users is enabled, with the added benefit of being able to keep a record of each and every communication, interaction and action in real time and time stamped for accurate and comprehensive record keeping.

### BRIEF DESCRIPTION OF THE DRAWING

FIG. 1 is a Block diagram of the “Preparation” phase of the invention.

FIG. 2 is a Block diagram of the “Performance or Execution” phase of the invention.

FIG. 3 is a Block diagram of the “Collaboration” phase/feature of the invention.

FIG. 4 is a Block diagram of the “Coordination” phase/feature of the invention.

FIG. 5 is a Block diagram of the “Record and Update” phase/feature of the invention.

FIG. 6 is a depiction of Listing 1, displaying an example of a Workpacket.

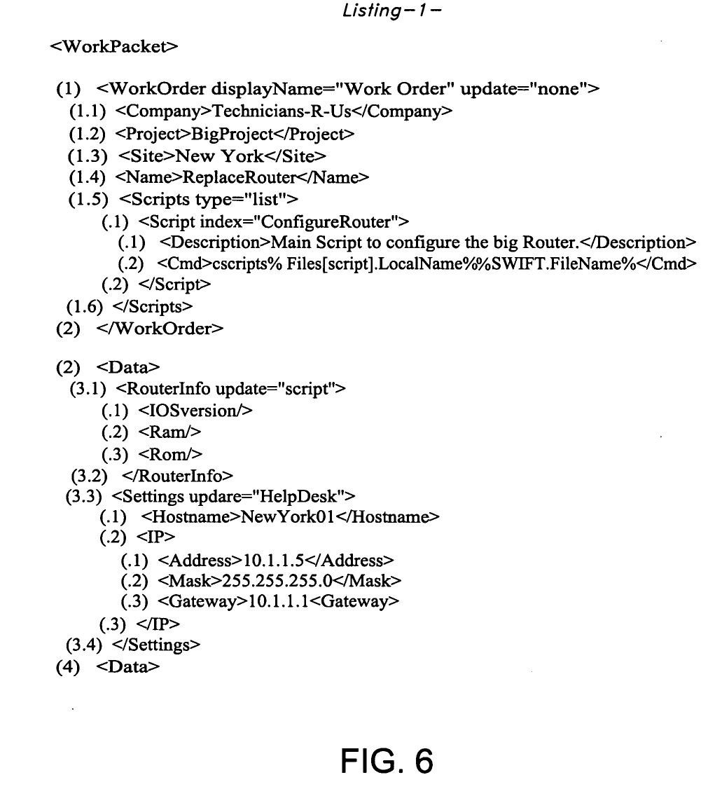

FIG. 7 is a depiction of a continuation of Listing 1, displaying an example of a Workpacket.

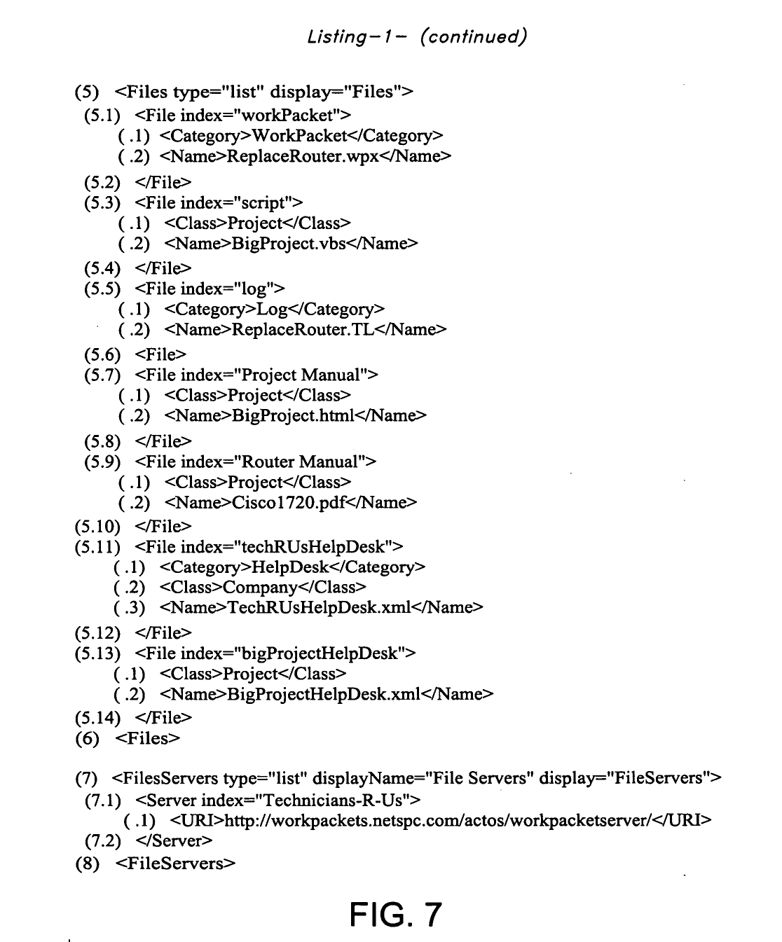

FIG. 8 is a depiction of a continuation of Listing 1, displaying an example of a Workpacket.

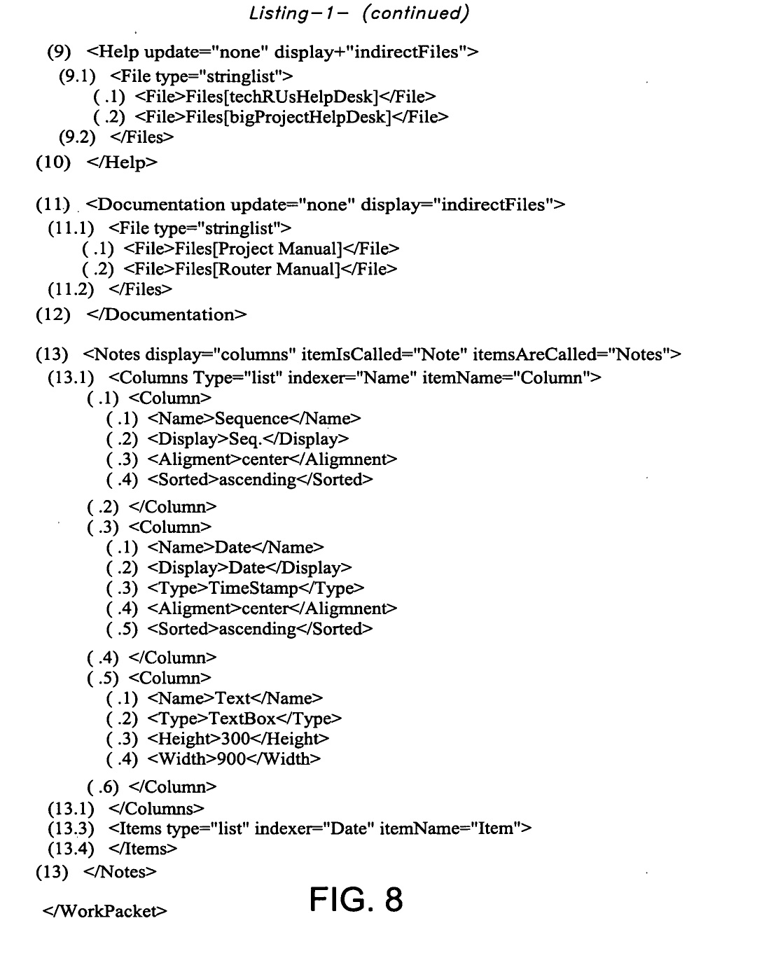

FIG. 9 is a depiction of Listing 2, displaying an example of “Request”.

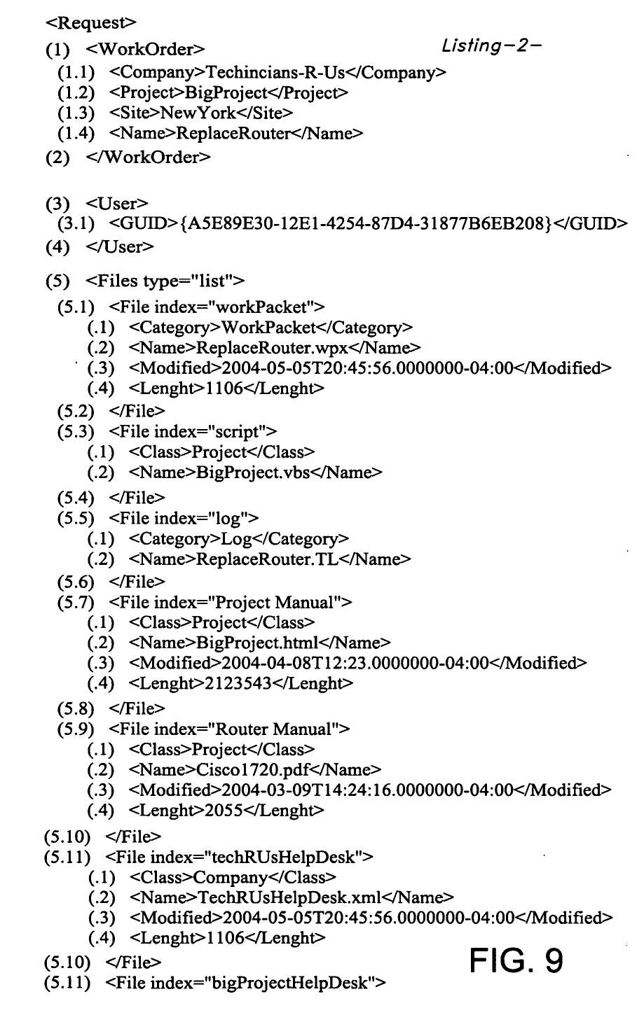

FIG. 10 is a depiction of a continuation of Listing 2, displaying an example of “Request”

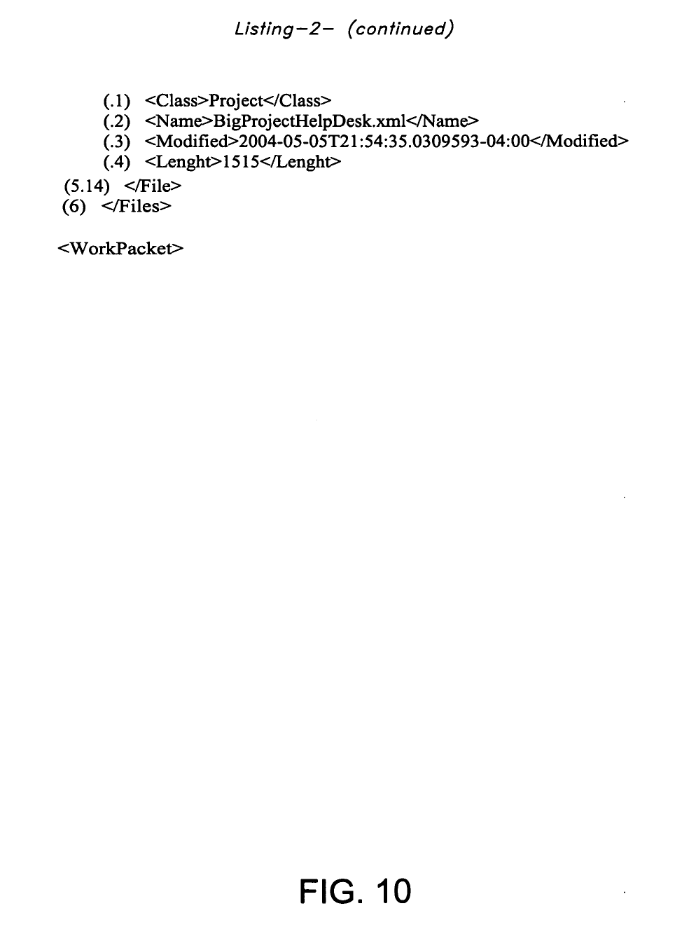

FIG. 11 is a depiction of Listing 3, displaying an example of “Response”.

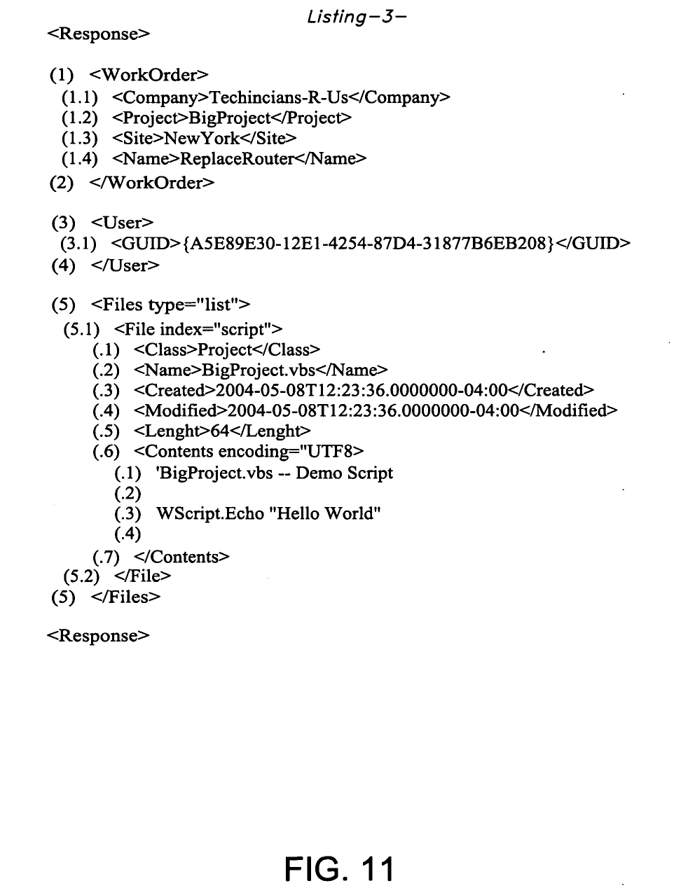

FIG. 12 is a depiction of Listing 4, displaying an example of “HelpFile”.

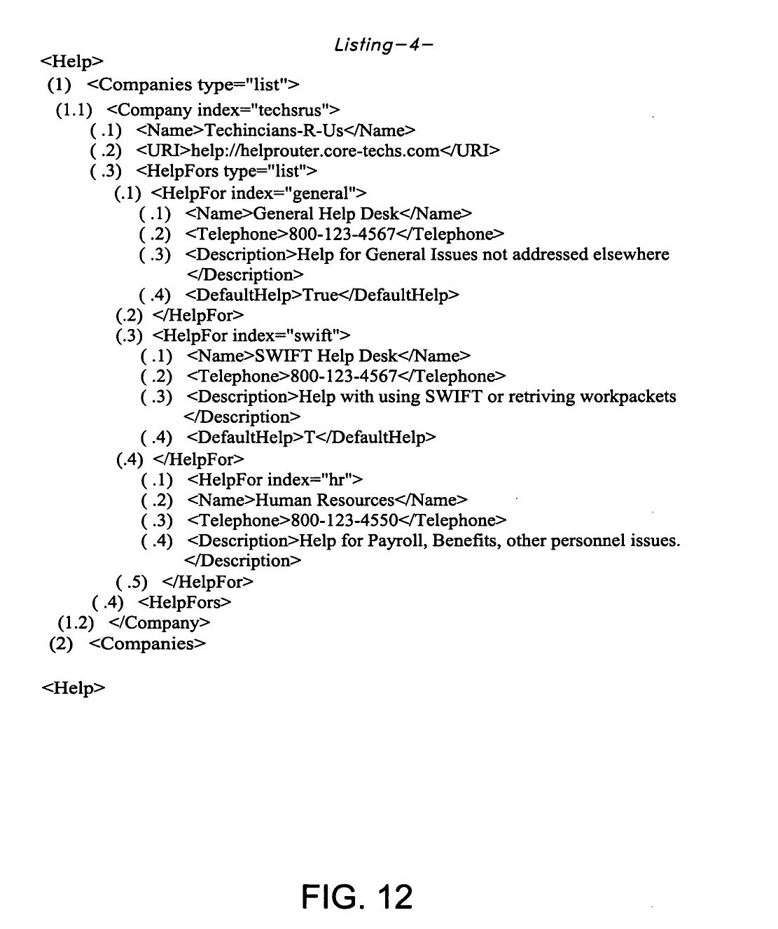

### DETAILED DESCRIPTION OF THE INVENTION

There will be detailed below the preferred embodiments of the present invention with reference to the accompanying drawings. Like members are designated by like reference characters in all figures.

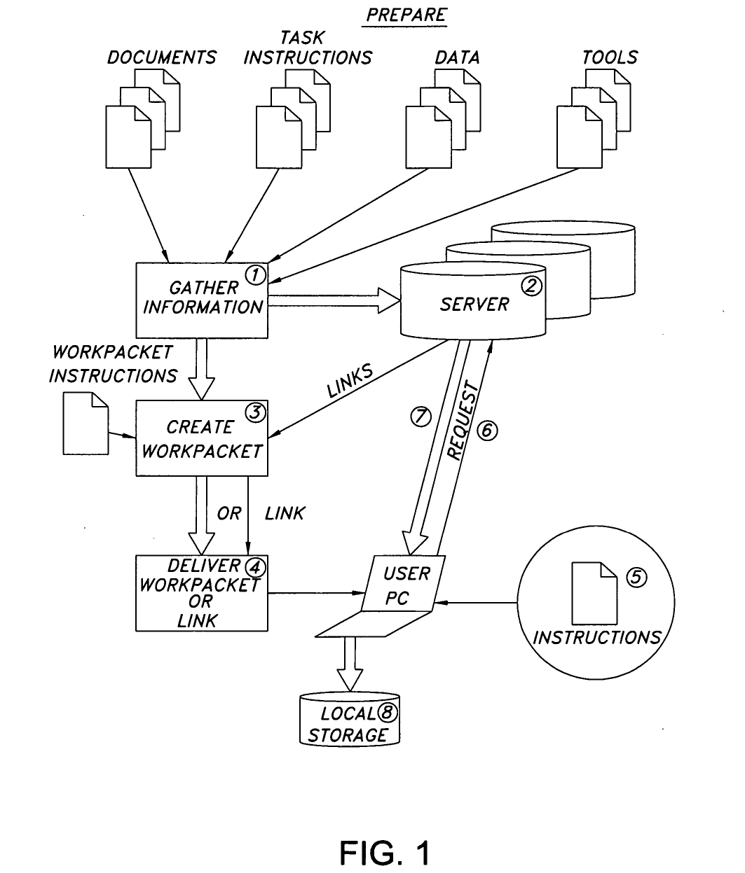

The invention in its preferred embodiment begins with a “PREPARATION” phase as illustrated in FIG. 1. In the preparation phase, the invention is used to get all the required data, documents, task instructions, and software tools, known as “collateral” pre-loaded onto the PC that will be used to perform the task. This activity centers on an electronic repository of data, information, software, and instructions, referred to as the “WorkPacket” that contains all the data and instructions necessary to complete the preparation phase.

Referring to FIG. 1, in step 1 of this phase, the user of the invention gathers, in an electronic format, the data, documents, task instructions, and software tools required to perform one or more tasks for inclusion in the “WorkPacket”. The user has the option of storing large files, and files that are used in more than one WorkPacket, on a server. When files are stored on a server, a link to the data will be embedded in the WorkPacket instead of the actual information. In this implementation of the invention, the collateral is stored on the server using a simple structure where the data is grouped into nested directories using the simple hierarchy of Company, Project, and Site. The collateral that is aggregated in the WorkPacket is typically generated by an individual having responsibility for the entire scope of the project such as a project manager. The project manager would therefore obtain information about the work to be performed including the client's name, and project particulars such as equipment to be serviced or installed, the physical location and layout of the equipment, the identity of the contact individual at the project location. In addition, the project manager would coordinate providing any software that the technician will need in performing the assigned service. The information contained in the WorkPacket can not only be software and detailed instructions, but also include scanned schematics, diagrams, maps photographs and any other documentation germane to the service that the technician will be performing. The Workpacket can contain dynamic software modules that are provided to the technician in support of his tasks that he is scheduled to perform. Once all of the collateral is gathered together by the project manager, it can be saved in a highly formalized electronic format and compiled as the WorkPacket.

In addition to assembling all of the collateral for inclusion into the WorkPacket the project manager in response to a work order, service order or service request, will communicate with the client to determine the scope of the services to be provided and any unusual requirements. The project manager may also obtain information with respect to the project site such as location and layout, contact individuals that the field service technician may need to complete his work. The contact individuals may include the client's technical representative or representatives, project supervisors, and third party contact individuals. Third party contact individuals can be particularly important when the work being performed involves equipment or software procured from a vendor other than the client. In this way, the field service technician can have quick and efficient access to all technical individuals needed to perform the assigned tasks.

In step 2, of FIG. 1, a WorkPacket is created using a flexible “XML” format, as illustrated in Listing 1. The outermost or “document” section is <WorkPacket>. It encloses the primary sections, identified in the Listing 1 by the XML tags (1) WorkOrder, (3) Data, (5) Files, (7) FileServers, (9) Help, (11) Documentation, and (13) Notes. The invention divides primary sections into two types, instruction sections and data sections. The invention follows the instructions embedded in the instruction sections with the reserved tag names: “WorkOrder”, “Files”, “File Servers”, and “Help”. The user of the invention is free to include as many primary sections as they see fit with the restriction that each tag name must be unique.

In the example provided, the primary sections of the Workpacket include the listing identified by the XML tags. The tags provide specific identifiers for each of the categories of information contained in a Workpacket. For example, the Data tag is used to identify data required for the completion of the work order tasks, the data can include for example, specifications for a particular piece of equipment. The Files tag is used to identify aggregations of information and data into common categories known as files. The FileServers tag may be used to identify the particular server computer associated with a particular data structure or file. The Help tag may be used to identify the files corresponding to user assistance. The Documentation tag is used to identify any collateral to be included in the WorkPacket for use by the technician in performing the service tasks. The Notes tag may typically be used to identify any additional information which is included in the WorkPacket for use by the technician in performing the assigned service tasks.

The WorkOrder, Files, and FileServers sections are used by the invention in the Preparation phase. They contain the instructions the invention will follow in order to complete the Preparation phase. Typically, for instance, WorkOrder refers to the actual order for service(s), typically being the scope of work to be performed, the work location, and other details related to the performance of the job.

In Listing 1, the (1) WorkOrder section contains tags: (1.1) Company, (1.2) Project, (1.3) Site, and (1.4) Name that uniquely identify the WorkPacket. The (1.5) Scripts tag is a list of automated tasks that this WorkPacket can perform. In this example, the only task that can be performed is “Configure Router” as indicated by the “index” attribute of the (1.5.1) SCRIPT tag, however, it should be apparent to one skilled in the art that other automated tasks can be added to the (1.5) Scripts tag and performed by the WorkPacket.

In step 3, of FIG. 1, the user of invention creates a WorkPacket similar to the one in Listing 1.

In step 4, of FIG. 1, the WorkPacket is delivered to the PC that will be used to complete the task contained in the WorkPacket. The WorkPacket can be delivered in its entirety or as a link (URL) to a server. The computer-program embodiment of the invention, known as the SWIFT-Client, is executed on the target PC and is instructed to open the WorkPacket. If the WorkPacket is identified as a URL it is first downloaded from the server identified in the URL.

In step 5, of FIG. 1, the WorkPacket is examined and the (1) WorkOrder section is verified to insure that the required (1.1) Company, (1.2) Project, (1.3) Site, and (1.4) Name tags are present and valid. Next the (5) Files section is checked and an appropriate request is sent to the server.

In step 6, of FIG. 1, a request is sent to the Server. Listing 2 shows the format of a request. A request is formed by updating the (5) Files section of Listing 1 with information about the files that are currently in the Local Storage.

In step 7, of FIG. 1, the Server responds to the request with a response. Listing 3 shows the format of the response. The response includes any files that are missing or that need to be updated. The request in Listing 2, indicates that the “script” file is missing in the (5.3) File entry. The server has responded with a copy of that file in the (5.1) File entry in Listing 3. Listing 3 is one representation of how the invention returns the data. There are a number of other ways to implement the return of the data. The most obvious improvement is to compress the data.

In step 8, of FIG. 1, all the files required to complete the task have been copied onto local storage allowing the task to be performed even if the network connection is not available. As a common use for the invention is a task to restore network connectivity or to diagnose the failure, the ability to have all the essential elements on site before the failure is a key feature of the invention. Another common use of the invention would be a task to configure and test replacement equipment that might be provided to recover from a loss of network connectivity. Again, because all the data, task instructions, documentation, and tools have been pre-loaded onto the local storage the invention is able to assist non-technical people in resolving a critical failure.

In step 9, of FIG. 1, any files that have been updated by this or previous runs of the WorkPacket are uploaded to the Server to create a permanent record of the activities.

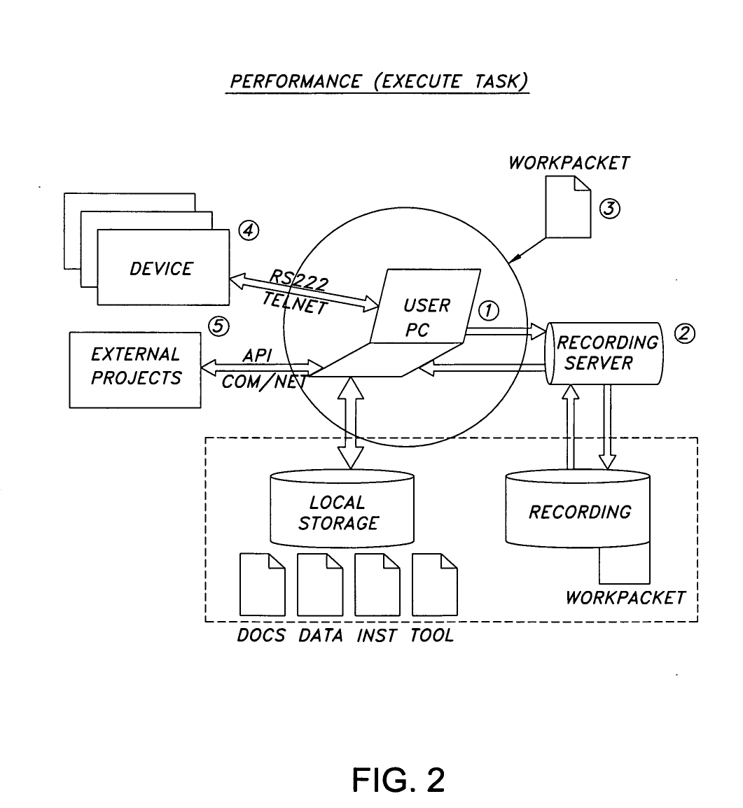

FIG. 2 illustrates the invention's actual performance of a task.

Step 1, of FIG. 2, is to load the inventions executable code, SWIFT-Client. Once this is loaded a new session is started and a record is created.

As Step 2, of FIG. 2, illustrates the recording is created via a “recording server”. It is important to notice that the data to be recorded and data retrieved from the recording all must flow through the recording server. Data is recorded as records each uniquely identified by a timestamp. Each record contains a user number, a channel, and the data as either a single character or a string of characters. The invention as embodied by SWIFT-Client is controlled by routines, called servers, that listen to the different channels in the recording by establishing a filter for one or more channels and one or more users.

In Step 3, of FIG. 2, the invention loads a WorkPacket either due to input form the user via the GUI or from a command on the command-line when the invention was invoked. This causes a WorkPacket load request record to be written on the “request” channel. This causes the appropriate server routine to be invoked causing the invention to load in the WorkPacket and store it in the record on the “WorkPacket” channel. The invention checks to see if the servers identified in the “FileServers” section of the WorkPacket are available. If so, the invention will send a request to the server (step 6 FIG. 1) to see if there are any updates to the files contained in Local Storage.

In Step 4, of FIG. 2, the invention optionally connects to one or more devices based on the task instructions contained in the WorkPacket. The user of the invention can also control the connection to external devices. Again, connecting to one or more devices is accomplished by writing a “Device Connect” request on the Device Status channel. The causes the appropriate server routine to connect to the device and assign the new device a “Input”, “Keyboard”, and “Script” channel. These will be used to record the input, keyboard output, and script output to the device during the session.

In Step 5, of FIG. 2, the invention is instructed to execute a script associated with the WorkPacket. This can be invoked by instructions from the user of the invention via the GUI, from the command line used when the invention was invoked, or by instructions contained in the WorkPacket itself. Using the standard “COM” interface the external tasks are able to interact with the WorkPacket, the record, the user, and the device.

The invention in its preferred embodiment supports “Collaboration” which allows any number of users to work together to diagnose and resolve any issues that might arise in the performance of a task.

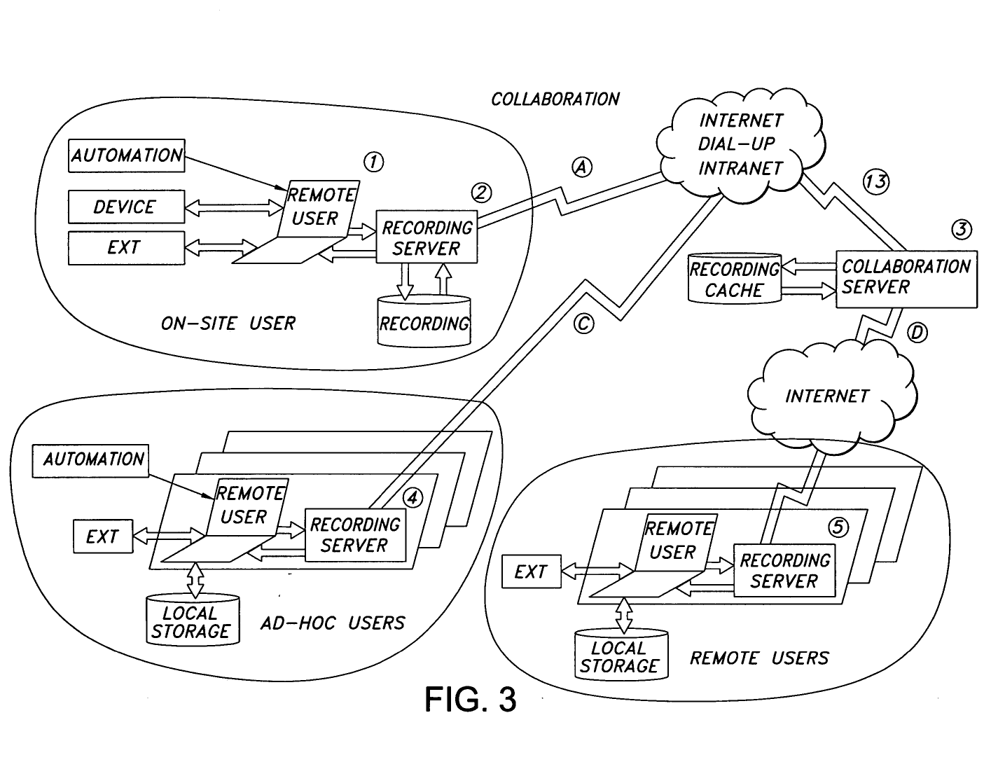

Referring to FIG. 3, in step 1 of this phase, the user of the invention is on-site and connected to a device as described in the Execution phase. In executing the SWIFT client the user has created a recording server and a recording of everything that has transpired.

In Step 2, of FIG. 3, the recording server creates a “listening” port to listen for connection requests from other users that want to collaborate with the on-site user.

In Step 3, of FIG. 3, the user optionally requests that the recording server connect to a collaboration server. Once this connection is established, the collaboration server will request a copy of the recording and store it in its recording cache. Depending on the type of connection the collaboration server will either poll the on-site recording server for recording updates or the on-site's recording server will periodically forward new records to the collaboration server's recording cache.

In Step 4, of FIG. 3, an ad-hoc remote user executes the SWIFT client and requests a “remote” session be established directly with the on-site user. This causes a connection request to be sent directly to the on-site user's recording server, which is listening for such requests. Once the request has been accepted the ad-hoc remote user's recording server request a copy of the recording which is stored in the ad-hoc remote user's memory. Depending on the type of connection the ad-hoc remote user will poll the on-site recording server for updates or the on-site's recording server will periodically forward new records.

Once the connection is established, the ad-hoc remote user is able to review the entire recording to ascertain everything that has been done before. As the WorkPacket is included in the recording the ad-hoc remote user is able to review the WorkPacket as well.

Should the ad-hoc remote user desire to interact with the device, the ad-hoc remote user would strike a key on his computer, this would cause a record to be created on the “Device.Keyboard” channel. The ad-hoc remote user's recording server would forward this to the on-site user's recording server which would add the record to the recording and return the same record, now with a timestamp added, as part of the record. The ad-hoc remote user would now display the keystroke if the display is enabled to show the “Device.Keyboard” channel.

A service running as part of the on-site user's SWIFT program would be watching for activity on the “Device.Keyboard” channel and send the character to the device. Typically, the device would respond to the character by echoing it back to the computer. The same service that forwarded the character to the device would accept the echoed character and create a record on the “Device.Input” channel with the echoed character and forward it to the recording server. The recording server would then add it to the recording and forward it to the remote user (or users). At this point, the display servers on each machine would notice a new “Device.Input” record and update the display to show the new character that was received.

This is just one example of the ability of the remote user to interact with the device. Because the invention uses a model of writing requests (as records) to specific channels in the recording and then having servers listening for those request and responding, anything the on-site user can do, the remote user can do.

Because the on-site user's link to the Internet can be very slow, commonly a dial-up connection, having a large number of users connecting directly to the on-site user and retrieving the entire record can easily swamp the low speed connection, most users will connect to the collaboration server instead.

In step 5, of FIG. 3, another remote user connects to the collaboration server indicating which on-site user they are attempting to assist. This differs from the Ad-hoc remote user in that they connect to the server—not directly to the on-site user.

The collaboration server forwards the connection request to the on-site user to validate the remote-user and to add that user to the on-site session. Once the connection is accepted the collaboration server will indicate that the connection has been accepted and send the existing records in the recording to the remote user.

From this point on the process is very similar to the ad-hoc remote user except that records to be added by the remote user are send to the collaboration server where they are forwarded to the on-site user's recording server where they are added to the recording and acted upon.

Records that are added to the recording are copied to the collaboration server who adds them to its cache where they are further copied to each remote user using the collaboration server.

The preferred embodiment of the invention places no limits on the number or combinations of ad-hoc remote users, collaboration servers, or remote users.

The Invention in its preferred embodiment supports “Coordination” which allows users needing help to connect with other users offering help.

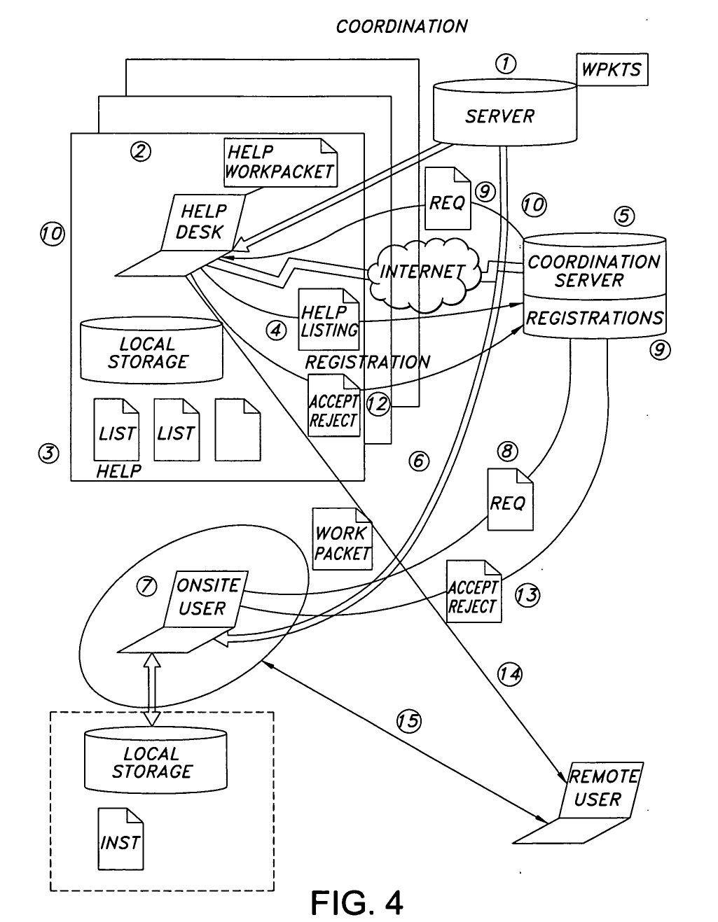

Referring to FIG. 4, in step 1, HelpDesk WorkPackets are created containing a Help Section similar to the Help section in Listing 1 line 9. The help section references other files containing HelpLists. An example is provided as Listing 4.

In Step 2, of FIG. 4, a Help Desk user loads a HelpDesk WorkPacket which connects to the server and downloads all the HelpLists included in the HelpDesk WorkPacket.

In Step 3, of FIG. 4, the Help Desk user then selects from the various HelpFors offered and indicates which HelpFors they will offer help.

In Step 4, of FIG. 4, the HelpListing are combined into a “registration” that is sent to the “Coordination” server.

In Step 5, of FIG. 4, the “Coordination” server accepts the “registration” and stores it in its “Registrations” database.

In Step 6, of FIG. 4, an on-site user loads their WorkPacket, which includes copying a HelpLists to their local storage.

In Step 7, of FIG. 4, the on-site user selects a HelpFor from the HelpList.

In Step 8, of FIG. 4, the on-site user sends this “request” to the coordination server.

In Step 9, of FIG. 4, the coordination server matches the request with the registrations and picks the best match for the request and forwards the request to the registered help desk. If no match is found steps 10 through 12 are skipped.

In Step 10, of FIG. 4, the “request” is forwarded to the matching help desk.

In Step 11, of FIG. 4, the help desk user is presented with the request and allowed to accept or reject the request.

In Step 12, of FIG. 4, the help desk sends a “accept” or “reject” response to the coordination server. If the request is “rejected” the coordination server returns to step 9.

In Step 13, of FIG. 4, an “accept” or “reject” response is sent to the on-site user. If the request is rejected the remaining steps on FIG. 4 do not occur.

In Step 14, of FIG. 4, the HelpDesk application launches a copy of the Swift Client with the appropriate startup options to connect the remote user to the on-site user.

In Step 15, of FIG. 4, the newly launched copy of Swift client connects to the on-site user's copy of Swift Client using the “Collaboration” techniques described earlier.

The Invention in its preferred embodiment supports a “Record and Update” phase, which facilitates returning (uploading) recordings, WorkPackets, and other collateral files collected during the execution phase to the appropriate Server and to simultaneously download updates to WorkPackets and updated collateral.

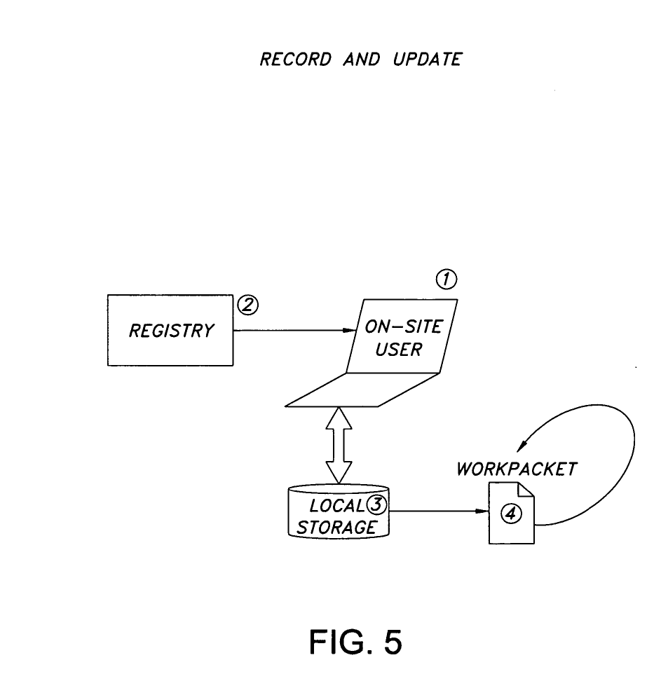

Referring to FIG. 5, in step 1, the user loads the SWIFT-Client software and executes an Update command either via the GUI or form a command line option.

In step 2, of FIG. 5, the SWIFT-Client software accesses the registry and retrieves the start-time of the last “record and update” phase.

In step 3, of FIG. 5, the local storage used to hold WorkPackets and collateral is scanned for any files updated since the last “record and update” phase. When updated files are located, perform steps 4.

In step 4, of FIG. 5, the updated WorkPacket is loaded and its file section is processed as specified in steps 5 through 9 of FIG. 1.

It will be appreciated that the present invention has been described herein with reference to certain preferred or exemplary embodiments. The preferred or exemplary embodiments described herein may be modified, changed, added to, or deviated from without departing from the intent, spirit, and scope of the present invention. It is intended that all such additions, modifications, amendments, and/or deviations be included within the scope of the claims appended hereto.

1) A method for providing workforce management comprising:
aggregating in a comprehensive database a set of data, documentation, instructions and tools for the performance of at least one task, loading said comprehensive database onto at least one computer for the performance of said tasks,
performing said at least one task, and
creating a record of said execution of said at least one task.

2) A method as in claim 1, further including retrieving additional data, documentation and tools based upon said instructions.

3) A method as in claim 1, further including returning additional data, documentation and tools based upon said instructions.

4) A method as in claim 1, wherein performing said task includes instantiating an external process.

5) A method as in claim 1, wherein performing said task includes providing access to said comprehensive database.

6) A method as in claim 1, wherein creating a record includes providing access for an external process to read and add data to said record.

7) A method as in claim 1, wherein said comprehensive database becomes a part of said record.

8) A method as in claim 1, wherein loading said comprehensive database includes loading from a network.

9) A method as in claim 1, wherein loading said comprehensive database includes loading from portable media.

10) A method as in claim 1, further including returning said record to a repository.

11) A method as in claim 10, wherein returning said record to a repository is by a network.

12) A method as in claim 10, wherein returning said record to a repository is by portable media.

13) A method as in claim 1, wherein creating a record includes receiving input datum from a plurality of sources.

14) A method as in claim 13, wherein receiving input datum from a plurality of sources includes identifying and recording said sources of said datum.

15) A method as in claim 13, wherein receiving input datum from a plurality of sources includes identifying and recording the time of said input.

16) A method as in claim 1 wherein said comprehensive database is an XML document.

17) A method for providing real time collaborative support amongst a plurality of entities comprising;
executing by an entity at least one activity,
creating a record of said execution of said at least one activity,
adding entities through the process comprising;
requesting assistance from at least one support entity, by any of said plurality of users,
creating an electronic communication link from said support entity to said entity,
providing said record from said entity to said support entity, and
sharing control of said executing of said at least one activity.

18) A method for providing real time collaborative support as in claim 17, wherein requesting assistance further includes;
creating a classification database of resource classifications,
sharing said classification database among a plurality of resources and resource users,
registering an address and resource classification for each of said plurality of resources,
receiving a request for at least one resource from said resource user,
searching for at least one matching resource, and
returning said resource to said resource user.

19) A method as in claim 17, wherein said database is a part of said record.

20) A method as in claim 17, further including returning said record to a repository.

21) A method as in claim 20, wherein returning said record to a repository is by a network.

22) A method as in claim 20, wherein returning said record to a repository is by portable media.

23) A method as in claim 17, wherein creating a record includes receiving input datum from a plurality of sources.

24) A method as in claim 17, wherein receiving input datum from a plurality of sources includes identifying and recording said sources of said datum.

25) A method as in claim 17, wherein receiving input datum from a plurality of sources includes identifying and recording the time of said input.

26) A method as in claim 18 wherein said classification database is an XML document.

27) A method for coordinating collaborative resources comprising;
creating a classification database of resource classifications,
sharing said database among a plurality of resources and resource users,
registering an address and resource classification for each of said plurality of resources,
receiving a request for at least one resource from said resource user,
searching for at least one matching resource, and
returning said resource to said resource user.

28) A method for coordinating collaborative resources as in claim 27, wherein said classification database is an XML document.

29) A method for coordinating collaborative resources as in claim 28, wherein said XML document contains hierarchical resource classifications.

30) A method for coordinating collaborative resources as in claim 27, wherein registering an address includes automatically re-registering after a pre-determined time interval.

31) A method for coordinating collaborative resources as in claim 27, wherein returning a resource includes returning multiple resources.

32) A method for providing workforce management and collaborative support amongst a plurality of entities comprising;
aggregating in a comprehensive database a set of data, documentation, instructions and tools for the performance of at least one task,
loading said comprehensive database onto at least one computer for the performance of said tasks,
performing said at least one task,
creating a record of said execution of said at least one task,
adding entities through the process comprising;
requesting assistance from at least one support entity by any of said plurality of entities,
creating an electronic communication link from said support entity to said entity,
providing said record from said entity to said support entity, and
sharing control of said executing of said at least one task.

33) A method as in claim 32 further including retrieving additional data, documentation and tools based upon said instructions.

34) A method as in claim 32, further including returning additional data, documentation and tools based upon said instructions.

35) A method as in claim 32, wherein said comprehensive database becomes a part of said record.

36) A method as in claim 32, wherein loading said comprehensive database includes loading from a network.

37) A method as in claim 32, wherein loading said comprehensive database includes loading from portable media.

38) A method as in claim 32, further including returning said record to a repository.

39) A method as in claim 38, wherein returning said record to a repository is by a network.

40) A method as in claim 38, wherein returning said record to a repository is by portable media.

41) A method as in claim 32, wherein creating a record includes receiving input datum from a plurality of sources.

42) A method as in claim 41, wherein receiving input datum from a plurality of sources includes identifying and recording said sources of said datum.

43) A method as in claim 41, wherein receiving input datum from a plurality of sources includes identifying and recording the time of said input.

44) A method as in claim 32 wherein said comprehensive database is an XML document.

45) A method of workforce management and coordinating collaborative resources comprising;
A method for providing workforce management and collaborative support amongst a plurality of entities comprising;
aggregating in a comprehensive database a set of data, documentation, instructions and tools for the performance of at least one task,
loading said comprehensive database onto at least one computer for the performance of said tasks,
performing said at least one task,
creating a record of said execution of said at least one task,
adding entities through the process comprising;
requesting assistance from at least one support entity by any of said plurality of entities, wherein requesting assistance includes;
creating a classification database of resource classifications,
sharing said database among a plurality of resources and resource users,
registering an address and resource classification for each of said plurality of resources,
receiving a request for at least one resource from said resource user,
searching for at least one matching resource, and
returning said resource to said resource user,
creating an electronic communication link from said support entity to said entity,
providing said record from said entity to said support entity, and
sharing control of said executing of said at least one task.

46) A method as in claim 45, further including retrieving additional data, documentation and tools based upon said instructions.

47) A method as in claim 45, further including returning additional data, documentation and tools based upon said instructions.

48) A method as in claim 45, wherein said comprehensive database becomes a part of said record.

49) A method as in claim 45, wherein loading said comprehensive database includes loading from a network.

50) A method as in claim 45, wherein loading said comprehensive database includes loading from portable media.

51) A method as in claim 45, further including returning said record to a repository.

52) A method as in claim 51, wherein returning said record to a repository is by a network.

53) A method as in claim 51, wherein returning said record to a repository is by portable media.

54) A method as in claim 45, wherein creating a record includes receiving input datum from a plurality of sources.

55) A method as in claim 54, wherein receiving input datum from a plurality of sources includes identifying and recording said sources of said datum.

56) A method as in claim 54, wherein receiving input datum from a plurality of sources includes identifying and recording the time of said input.

57) A method as in claim 45 wherein said comprehensive database is an XML document.

58) A method as in claim 45, wherein said classification database is an XML document.

59) A method as in claim 45, wherein said XML document contains hierarchical resource classifications.

60) A method as in claim 45, wherein registering an address includes automatically re-registering after a pre-determined time interval.

61) A method as in claim 45, wherein receiving a request for one of said services is by a real time network link.

62) A method as in claim 45, wherein returning a resource includes returning multiple resources.

63) A method for allowing at least one user to interact simultaneously with multiple entities comprising;
creating an event database for storing events comprising a time stamp, a channel, a user and event data,
assigning channels to each input of said devices,
assigning channels to each output of said devices,
assigning a user identification to each of said at least one users,
recording events in said event database wherein each event is recorded with said time stamp, said channel and said users,
displaying said events to one of said at least one users based upon pre-determined criteria.

64) The method of claim 63 wherein said multiple entities are devices.

65) The method of claim 63 wherein said multiple entities are processes.

66) The method of claim 63 wherein said multiple entities are both devices and processes.

67) The method of claim 63 wherein said channels are script, keyboard and input.

68) The method of claim 63 wherein said channels are message channels.
